(19) United States
(12) Patent Application Publication
(10) Pub. No.: US 2020/0166079 A1
(43) Pub. Date: May 28, 2020

(54) METHOD FOR PRODUCING A PRECISION RAIL AND A PRECISION RAIL GUIDE, AND PRECISION RAIL AND PRECISION RAIL GUIDE

(71) Applicants: Aktiebolaget SKF, Gothenburg (SE); SKF Motion Technologies AB, Gothenburg (SE)

(72) Inventors: Juergen Gegner, Forchheim (DE); Henryk Velde, Werneck (DE)

(21) Appl. No.: 16/690,985

(22) Filed: Nov. 21, 2019

(30) Foreign Application Priority Data
Nov. 22, 2018 (DE) 102018220056

(51) Int. Cl. F16C 33/62; F16C 29/00; F16C 29/04; F16C 33/64

(52) U.S. Cl. CPC F16C 33/62; F16C 29/005; F16C 2223/46; F16C 33/64; F16C 2204/70; F16C 29/04

(57) ABSTRACT

A production method produces a precision rail having a raceway region. The material for producing at least one part of the raceway region is deposited onto a component by laser beam build-up welding and/or electron beam build-up welding. The methods results in short processing times being achieved when the precision rails concerned are produced.

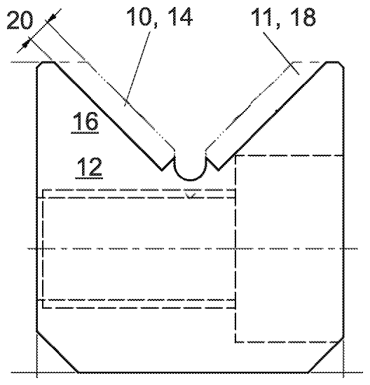

### CROSS-REFERENCE TO RELATED APPLICATION

This application claims the priority, under 35 U.S.C. § 119, of German application DE 10 2018 220 056, filed Nov. 22, 2018; the prior application is herewith incorporated by reference in its entirety.

### BACKGROUND OF THE INVENTION

### Field of the Invention

The invention proceeds from a precision rail production method as per the preamble of the independent method claim.

A precision rail production method is known in which a part of an unworked profile made of 90MnCrV6 is detached. Subsequently, through-bores for fastening screws are created and end machining takes place. After hardening, straightening is performed, and a delivery-ready product is obtained by rough-grinding, finish-grinding, preserving and packaging.

### SUMMARY OF THE INVENTION

The object of the invention is in particular that of achieving efficient production. The object is achieved according to the invention by the features of the independent patent claim, while advantageous configurations and refinements of the invention can be gathered from the dependent claims.

The invention proceeds from a precision rail production method, in which a raceway region is formed.

It is proposed that material for forming at least one part of the raceway region is deposited onto a component by laser beam build-up welding and/or electron beam build-up welding, in particular in one or in multiple layers. According to the invention, efficient production can be achieved. In particular, short processing times can be achieved when the precision rails concerned are produced. Flexible drilling machining can also be achieved, since the drilling machining can take place before or after the hardening and grinding process, as a result of which less waste accumulates. Moreover, it is possible to significantly reduce or even dispense with straightening processes. In particular, the invention has the effect that hardening already takes place during the laser beam build-up welding or electron beam build-up welding, as a result of which the use of separate hardening installations or delivery to an external hardening plant is dispensed with. In particular, the hardening is more environmentally friendly and resource-conserving. In addition, material costs for the component are low. Furthermore, in particular high-grade material forming the raceway region can be used to a minimized extent and thus very efficiently.

Further advantages become apparent from the following description of the drawing. In the drawing, an exemplary embodiment of the invention is shown. The drawings, the description and the claims contain numerous features in combination. The features will also expediently be considered individually and combined into appropriate further combinations by a person skilled in the art.

Other features which are considered as characteristic for the invention are set forth in the appended claims.

Although the invention is illustrated and described herein as embodied in a precision rail production method, and a precision rail, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The FIGURE of the drawing is an illustration showing a precision rail in an incompletely produced state according to the invention.

### DETAILED DESCRIPTION OF THE INVENTION

Referring now to the single FIGURE of the drawings in detail thereof, there is shown a view of an end side of a precision rail in a state in which a first raceway region 10 and a layer 18, which forms a second raceway region 11, have yet to be deposited onto a component 12 of the precision rail. Spatial boundaries of the layer 18 and of the raceway region 10 are shown by dashed lines in the FIGURE. The component is a main body of the precision rail and, in an incompletely produced state of the precision rail, has a mass of more than 70% of the total mass of the precision rail.

In the method for producing the precision rail, material for producing the raceway region 10 is deposited onto the component by laser beam build-up welding (also referred to as “laser cladding”). For this purpose, the material, in the form of a welding wire that can originate continuously from a coil, is liquefied in a manner spatially adjacent to a region 16 of the component provided to support the raceway region 10, wherein the liquefied wire is applied to the region 16 in a meandering manner and immediately solidifies. In order that a main body has the desired temperature immediately before the application of the material, the main body can be preheated or precooled. When applying the material to the region 16, the volume of the main body ensures a desired cooling rate in the applied material, such that a fine-grained martensitic microstructure having a hardness in the range of greater than 55 HRC is obtained. Thus, hardening of the raceway region 10 takes place together with the application of the material, saving process costs and time. Finally, the raceway region 10 is a layer which consists of the material, has a thickness of approximately 1 mm and is fastened to the component in a material-bonded manner.

In addition, a thermal pre-treatment and/or post-treatment and a subsequent heat treatment for improving the microstructure properties and strength properties, in particular of the surface layer and transition layer of the raceway region 10, can also take place.

A laser beam is used to liquefy the wire. In an alternative embodiment of the invention, an electron beam, instead of the laser, is used continuously (electron beam build-up welding, also known as “electron beam cladding”).

The wire can in particular be made of rolling-bearing steel, tool steel, high-speed steel, a high-alloy steel, such as e.g. 100Cr6 (material number 1.3505), 100CrMnSi6-4 (100CrMn6, 1.3520), 100CrMo7-3 (1.3536), 100CrMnMo8 (1.3539), 110MnCrTi8 (1.8425), M50 (80MoCrV42-16, 1.3551), Cronidur 30 (X30CrMoN15-1, 1.4108), X2CrNiMo17-12-2 (1.4404) or X45CrSi9-3 (1.4718).

Overall, for the method described, in particular in the case of laser beam build-up welding, for example a powder or a strip can also be used instead of a wire. A relatively large selection of materials (welding fillers) is already available in powder form, because powder can be produced more easily than a wire or a strip. Multiple materials can also be deposited together or in a manner layered in multiple layers one on top of another by the build-up welding according to the invention. For this purpose, for example wires or powders made of different materials or else powder mixtures are used.

The component consists of cast iron (e.g. nodular cast iron, GJS, or austenitic-ferritic spheroidal-graphite cast iron, ADI). In other embodiments of the invention, the component can consist, for example, of structural steel or heat-treatable steel, thus for example steel S185, steel S235, steel S275, steel S295, steel S355, or steel S460 (various variants and material numbers are possible in each case, e.g. S235JR, S235JRG1, S235JRG2) or steel C22 (1.0402). Thus, the layer 14 consists of a material of higher grade than the material of the component, i.e. in particular a relatively high lifetime can be expected with rolling stress (surface layer stress). Since the layer 14 and the main body are made of various ferrous materials, they bond well in a material-bonded manner with one another.

A layer 18 forming the second raceway region 11 is produced analogously to the layer 14. After production of the precision rail has been completed, the precision rail and a further rail are joined together in a known manner with rolling bodies (not shown), which are formed by rollers in the present case, to give a complete precision rail guide.

### LIST OF REFERENCE SIGNS

| | |
|---|---|
| 10 | Raceway region |
| 11 | Raceway region |
| 12 | Component |
| 14 | Layer |
| 16 | Region |
| 18 | Layer |
| 20 | Thickness |

1. A method for producing a precision rail, which comprises the steps of:
providing a component; and
forming a raceway region, material for producing at least one part of the raceway region being deposited onto the component by laser beam build-up welding and/or electron beam build-up welding.

2. The method for producing the precision rail according to claim 1, wherein the material is deposited in one layer or in multiple layers.

3. The method for producing the precision rail according to claim 1, wherein the material contains rolling-bearing steel and/or tool steel and/or high-speed steel and/or at least one high-alloy steel and/or 100Cr6 and/or 100CrMnSi6-4 and/or 100CrMo7-3 and/or 100CrMnMo8 and/or 110MnCrTi8 and/or 80MoCrV42-16 and/or X30CrMoN15-1 and/or X2CrNiMol 7-12-2 and/or X45CrSi9-3.

4. The method for producing the precision rail according to claim 1, wherein the component is formed at least partially of structural steel, heat-treatable steel and/or cast iron and/or a steel S185 and/or a steel S235 and/or a steel S275 and/or a steel S295 and/or a steel S355 and/or a steel S460 and/or steel C22 and/or nodular cast iron and/or austenitic-ferritic spheroidal-graphite cast iron.

5. The method for producing the precision rail according to claim 1, wherein the component is a main body of the precision rail.

6. The method for producing the precision rail according to claim 1, wherein the material forms a layer which has a thickness of less than 3 mm.

7. The method for producing the precision rail according to claim 1, wherein the material is provided as a wire and/or a strip and/or a powder.

8. The method for producing the precision rail according to claim 1, wherein various materials including the material are deposited in one layer or in multiple layers.

9. The method for producing the precision rail according to claim 1, wherein the material forms a layer which has a thickness of less than 2 mm.

10. The method for producing the precision rail according to claim 1, wherein the component and the raceway region form the precision rail being at least one rail of a precision rail guide.

11. A method for producing a precision rail guide, which comprises the steps of:
producing a precision rail by the sub-steps of:
providing a component; and
forming a raceway region, material for producing at least one part of the raceway region being deposited onto the component by laser beam build-up welding and/or electron beam build-up welding.

12. A precision rail for a precision rail guide, the precision rail comprising:
at least one part of a raceway region being formed by a layer; and
a region disposed directly adjacent to said layer, said layer having a higher metallurgical grade than a material of said region disposed directly adjacent to said layer.

13. A precision rail guide, comprising:
a precision rail, containing:
at least one part of a raceway region being formed by a layer; and
a region disposed directly adjacent to said layer, said layer having a higher metallurgical grade than a material of said region disposed directly adjacent to said layer.
